(19) United States
(12) Patent Application Publication
(10) Pub. No.: US 2020/0086982 A1
(43) Pub. Date: Mar. 19, 2020

(54) BLADE GUARD FOR UNMANNED AERIAL VEHICLE AND UNMANNED AERIAL VEHICLE SYSTEM

(71) Applicant: SZ DJI TECHNOLOGY CO., LTD., Shenzhen (CN)

(72) Inventors: Wei WANG, Shenzhen (CN); Lei ZHANG, Shenzhen (CN)

(21) Appl. No.: 16/688,516

(22) Filed: Nov. 19, 2019

Related U.S. Application Data
(63) Continuation of application No. PCT/CN2017/085186, filed on May 19, 2017.

(51) Int. Cl. B64C 27/20; B64C 11/00

(52) U.S. Cl. CPC B64C 27/20; B64C 2201/024; B64C 11/001

(57) ABSTRACT

The present disclosure provides a blade guard for an unmanned aerial vehicle (UAV). The UAV body has a plurality of arms disposed on the UAV body, each arm including a support portion for supporting a motor and an extension portion for connecting the support portion and the UAV body. The blade guard includes a cover and a fixing assembly. The fixing assembly includes a first sleeve fixing member and a second sleeve fixing member. The first sleeve fixing member includes a receiving cavity and a notch connected to the receiving cavity. When the support portion of the arm or the motor is received in the receiving cavity, the extension portion of the arm is rotatable along the notch to enable the extension portion of the arm to be received in the second sleeve fixing member, and the extension portion is then locked by the second sleeve fixing member.

### CROSS-REFERENCE TO RELATED APPLICATION

This application is a continuation application of International Application No. PCT/CN2017/085186, filed on May 19, 2017, the entire content of which is incorporated herein by reference.

### TECHNICAL FIELD

The present disclosure relates to the field of unmanned aerial vehicle (UAV) technology, and more specifically, to a blade guard for a UAV and a UAV system.

### BACKGROUND

A UAV is an unmanned aircraft operated by a radio remote control equipment and a self-contained program control device, and it has applications in the fields of aerial photography, agriculture, disaster relief, surveillance of infectious diseases, surveying and mapping, news reporting, and film and television shooting. With the increasing focus on the safety of the UAVs, the demand for the protection of the blades of the UAVs have also increased. Often, a UAV may include a separately designed fixed blade guard structure. However, the blade guard in the cannot be fixed with some designs of the UAV arms, such as a UAV arm with a wider top and a narrower bottom. As such, the safety of the flight of the UAV may be negatively impacted.

### SUMMARY

The embodiments of the present disclosure provide a blade guard for a UAV and a UAV system in which the blade guard may be fixed with different shapes of the UAV arms, thereby effectively ensuring the safety of the flight of the UAV.

One aspect of the present disclosure provides a blade guard for an unmanned aerial vehicle (UAV), the UAV comprising a body and a plurality of arms disposed on the UAV body, each arm including a support portion for supporting a motor and an extension portion for connecting the support portion and the UAV body. The blade guard includes a cover and a fixing assembly. The fixing assembly includes a first sleeve fixing member and a second sleeve fixing member connected to the first sleeve fixing member. The first sleeve fixing member includes a receiving cavity and a notch connected to the receiving cavity, and when the support portion of the arm or the motor is received in the receiving cavity, the extension portion of the arm is rotatable along the notch to enable the extension portion of the arm to be received in the second sleeve fixing member, and the extension portion is then locked by the second sleeve fixing member.

Another aspect of the present disclosure provides an unmanned aerial vehicle (UAV) system. The UAV system includes a UAV, that includes a UAV body and a plurality of arms disposed on the UAV body, each arm including a support portion for supporting a motor and an extension portion for connecting the support portion and the UAV body. The UAV system further includes a blade guard including a cover and a fixing assembly, the fixing assembly includes a first sleeve fixing member and a second sleeve fixing member connected to the first sleeve fixing member. The first sleeve fixing member includes a receiving cavity and a notch connected to the receiving cavity, and when the support portion of the arm or the motor is received in the receiving cavity, the extension portion of the arm is rotatable along the notch to enable the extension portion of the arm to be received in the second sleeve fixing member, and the extension portion is then locked by the second sleeve fixing member.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a structural diagram illustrating a UAV system according to an embodiment of the present disclosure.

FIG. 2 is a structural view of a blade guard of the UAV shown in FIG. 1.

FIGS. 3-5 are schematic views illustrating the assembly process of the blade guard of the UAV shown in FIG. 2.

### DETAILED DESCRIPTION OF THE EMBODIMENTS

The technical solutions provided in the embodiments of the present disclosure will be described below with reference to the drawings. However, it should be understood that the following embodiments do not limit the disclosure. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

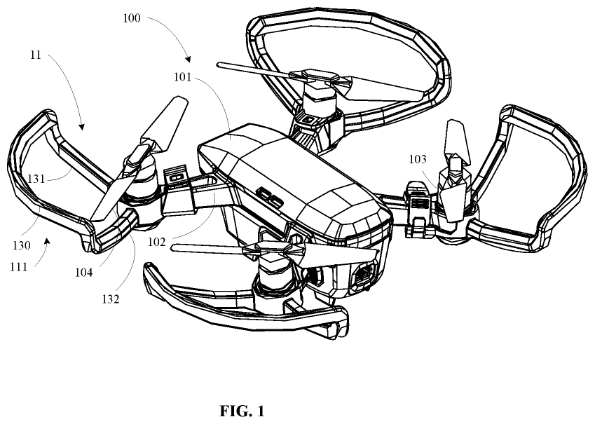

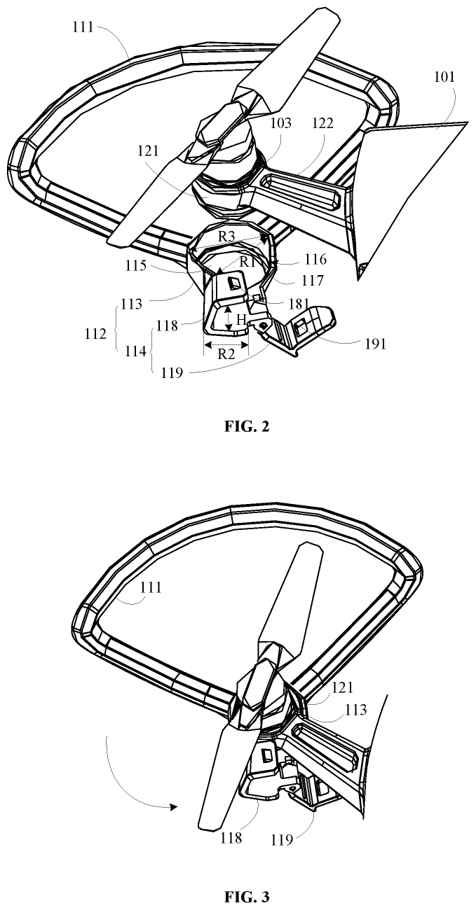

Referring to FIG. 1 and FIG. 2. FIG. 1 is a structural diagram illustrating a UAV system according to an embodiment of the present disclosure; and FIG. 2 is a structural view of a blade guard of the UAV shown in FIG. 1. As shown in FIG. 1 and FIG. 2, a UAV system 10 of the present disclosure includes a UAV 100 and a blade guard 11.

As shown in FIG. 1 and FIG. 2, the UAV 100 includes a body 101, a plurality of arms 102 disposed at four corners of the body 101, a motor 103 disposed at one end of the arm 102 away from the body 101, and a blade 104 driven by the motor 103. In the present embodiment, the arm 102 includes a support portion 121 for supporting the motor 103 and an extension portion 122 for connecting the support portion 121 and the body 101. The blade 104 may be a two-piece propeller structure. A blade guard 11 may be placed over the periphery of the blade 104 to protect the blade 104 from impact.

The motor 103 may be fixed in a tight fit with the support portion 121. In addition, relative portions of a snapping structure may be respectively provided on the support portion 121 and the motor 103, such that the support portion 121 and the motor 103 may be relatively fixed in a snap-fitting manner. In particular, the present disclosure does not limit the manner in which the support portion 121 and the motor 103 are fixed.

In one embodiment, the blade guard 11 may include a cover 111 and a fixing assembly 112 connected to the cover 111. Further, the cover 111 may include a cover body 130 and two cover connecting portions 131 and 132. The two cover connecting portions 131 and 132 may extend outward from the fixing assembly 112, the angle between the extending directions of the two cover connecting portions 131 and 132 may be less than 360°, and the ends of the two cover connecting portions 131 and 132 away from the fixing assembly 112 may be connected by the cover body 130.

The specific value of the angle between the extending directions of the two cover connecting portions 131 and 132 may be determined based on the specific situation. As long as the shape of the blade guard does not obstruct the camera and the visual sensors of the UAV 100, any arrangement of the blade guard should fall within the scope of protection set forth in the enclosed claims of the present disclosure.

In one embodiment, the fixing assembly 112 may be fixed to the periphery of the arm 102 of the UAV 100 in a nested manner, such that the cover 111 and the arm 103 may be relatively fixed. More specifically, the fixing assembly 112 may include a first sleeve fixing member 113 and a second sleeve fixing member 114 connected to the first sleeve fixing member 113. The first sleeve fixing member 113 may include a receiving cavity 115 and a notch 116 in communication with the receiving cavity 115. When the support portion 121 of the arm 102 or the motor 103 is at least partially received the receiving cavity 115, the extension portion 122 of the arm 102 may rotate along the notch 116 such that the extension portion 122 of the arm 102 may be at least partially received in the second sleeve fixing member 114, and the extension portion 122 may be locked by the second sleeve fixing member 114.

In the present embodiment, the receiving cavity 115 may be arranged to receive the support portion 121. In some embodiments, if one end of the motor 103 away from the blade 104 is flush with the end corresponding to the support portion 121, the receiving cavity 115 may be arranged to receive the support portion 121. Further, if one end of the motor 103 away from the blade 104 is protruding outward relative to the end corresponding to the support portion 121, the receiving cavity 115 may be arranged to receive the motor 103.

The notch 116 of the present embodiment may allow the extension portion 122 to slide into the second sleeve fixing member 114 from the notch 116 when the extension portion 122 is unable enter the second sleeve fixing member 114 directly from top to bottom. For example, when the structure of the extension portion 122 is relatively wider at the top and relatively narrower at the bottom, that is, the side closer to the blade 104 may be narrower than the side away from the blade 104. If the second sleeve fixing member 114 is arranged with the largest radial dimension of the extension portion 122, on one hand, it may be a waste of material; on the other hand, the excessively large second sleeve fixing member 114 may affect the locking effect on the extension portion 122. Therefore, the present disclosure provides a structure in which the second sleeve fixing member 114 may correspond to the extension portion 122, which may be relatively wider at the top and relatively narrower at the bottom, and the notch 116 is further provided. During assembly, the extension portion 122 may slide directly from the position of the notch 16, and the extension portion 122 may be rotated to the position of the second sleeve fixing member 114 to be locked with the second sleeve fixing member 114. As such, the cover 111 may be fixed, thereby effectively ensuring the safety of the flight of the UAV. Further, in the present disclosure the fixing assembly 112 of the blade guard 11 fixes the cover 111 and the arm 102, which may avoid the arrangement of a fixed structure on the UAV 100 and improve the miniaturization of the UAV 100.

In one embodiment, the first sleeve fixing member 113 may be disposed between the cover 111 and the second sleeve fixing member 114, and the notch 116 may be opened along the circumferential direction of the first sleeve fixing member 113. The receiving cavity 115 may be a cylindrically shaped cavity, and the support portion 121 may be at least partially inserted into the cylindrical receiving cavity along the axial direction of the cylindrical receiving cavity. In some embodiments, if the receiving cavity 115 is used to receive the motor 103, the motor 103 may be inserted into the cylindrical receiving cavity at least partially in the axial direction of the cylindrical receiving cavity.

In one embodiment, a circumferential dimension R1 of the notch 116 may be greater than a circumferential dimension R2 of a connecting portion of the second sleeve fixing member 114 and the first sleeve fixing member 113. In addition, a radial dimension R3 of the receiving cavity 115 and the circumferential dimension R1 of the notch 116 may be arranged such that when the support portion 121 or the motor is inserted into the receiving cavity 115 and the extension portion 122 is disposed in the notch 116, the support portion 121 and the extension portion 122 may rotate in the axial direction of the receiving cavity 115. As such, the extension portion 122 may be rotated to a position suitable for the second sleeve fixing member 114 to be fixed, thereby locking the extension portion 122 with the second sleeve fixing member 114.

In one embodiment, a necking structure 117 may be further disposed at the bottom of the receiving cavity 115. The necking structure 117 may be used to limit the support portion 121 or the motor 103 when the support portion 121 or the motor 103 is inserted into the receiving cavity 115. Alternatively, a screwing structure may be respectively disposed on the bottom of the receiving cavity 115 and an outer wall of the support portion 121 or the motor 103. The screwing structure may be used for screwing and fixing when the support portion 121 or the motor 103 is inserted into the receiving cavity 115. Further, a spiral structure may be respectively disposed on the bottom of the receiving cavity 115 and the outer wall of the support portion 121 or the motor 103. The spiral structure may be used for screwing and fixing when the support portion 121 or the motor 103 is inserted into the receiving cavity 115.

As described in the previous embodiments, the arm 102 and the cover 111 may be initially fixed by the first sleeve fixing member 113.

In addition, in one embodiment, the fixing strength between the arm 102 and the cover 111 may be further improved by the second sleeve fixing member 114. More specifically, the second sleeve fixing member 114 may include a fixing portion 118 and a movable connecting portion 119, and the fixing portion 118 may be fixedly connected to the first sleeve fixing member 113. More specifically, the fixing portion 118 may extend from the notch 116 of the first sleeve fixing member 113 in a direction away from the cover 111, and a lower edge of the notch 116 may smoothly transition into an inner side surface of the fixing portion 118. The lower edge of the notch 116 may be an edge that may abut the extension portion 122 when the support portion 121 or the motor 103 is inserted into the receiving cavity 115, and allow the extension portion 122 to rotate. Further, the lower edge of the notch 116 may smoothly transition into the inner side surface of the fixing portion 118, such that the extension portion 122 may be smoothly rotated into the fixing portion 118 of the second sleeve fixing member 114.

In one embodiment, the two cover connecting portions 131 and 132 may extend outward from the fixing portion 118, and the ends of the two cover connecting portions 131 and 132 away from the fixing portion 118 may be connected though the cover body 130.

The movable connecting portion 119 may be joined with the fixing portion 118 to form a closed structure that is sleeved on the periphery of the extension portion 122. That is, the extension portion 122 of the 102 and the cover 111 may be relatively fixed by the second sleeve fixing member 114.

In one embodiment, one end of the movable connecting portion 119 may be pivotally connected to one end of the fixing portion 118, and the other end of the movable connection portion 119 may be detachably connected to the other end of the fixing portion 118 in a snap-fitting manner. More specifically, a snapping part and a slot that may engage with each other may be arranged at one end of the fixing portion 119 and one end of the movable connecting portion 119. As shown in FIG. 2, a snapping part 181 is arranged on one end of the fixing portion 118, and a slot 191 that may engage with the snapping part 181 is arranged on one end of the movable connecting portion 119. It should be understood that, in some embodiments, the snapping part may be arranged on the other end of the movable connecting portion 119. Correspondingly, the slot may be arranged on the other end of the fixing portion 118.

In some embodiments, one end of the movable connecting portion 119 may also be connected to one end of the fixing portion 118 through a hinge connection, or an integral structure that may be deformed may be used to connect the movable connecting portion 119 and the fixing portion 118. The connection relation of the movable connecting portion 119 and the fixing portion 118 is not limited in the present disclosure. As long as the movable connecting portion 119 may be rotated from one end to the other end, and connect with the other end of the fixing portion 118 in a snap-fitting manner, it is within the scope of the present disclosure.

In one embodiment, the fixing portion 118 and the movable connecting portion 119 may form a shape that may be identical to the shape of the extension portion 122. For example, when the cross section of the extension portion 122 perpendicular to the extending direction thereof is a trapezoidal shape, the shape formed by the fixing portion 118 and the movable connecting portion 119 may be a corresponding trapezoidal shape. In some embodiments, the extension portion 122 may also have other shapes. For example, the cross section of the extension portion 122 perpendicular to the extending direction thereof may be a circle, an elliptical, etc. As long as the shape formed by the fixing portion 118 and the movable connecting portion 119 may be identical to the shape of the extension portion 122, a sufficient opening may not be provided on top of the fixing portion 118, and the extension portion 122 may have a shape that may not be directly inserted into the fixing portion, it is within the scope of the present disclosure.

In one embodiment, one of the fixing portion 118 and the movable connecting portion 119 may have a substantially C-shaped structure, and one of the fixing portion 118 and the movable connecting portion 119 may have a substantially L-shaped structure. As shown in FIG. 2, the fixing portion 118 of the present embodiment is arranged in a substantially C-shaped structure, and the movable connecting portion 119 is arranged in a substantially L-shaped structure. As such, when the support portion 121 or the motor 103 rotates in the axial direction of the receiving cavity 115, the extension portion 122 of the arm 102 may be screwed into the fixing portion along the notch 116.

In the present embodiment, a height H of the fixing portion 118 may be set to be equal to the thickness of the extension portion 122. Alternatively, the height H of the fixing portion 118 may be set to be slightly less than the thickness of the extension portion 122. As such, when the extension portion 122 is screwed into the fixing portion 118, the fixing portion 118 may be slightly elastically deformed, thereby applying pressure to the extension portion 122 such that the extension portion 122 may not move freely. In addition, the width of the fixing portion 118 may also be set in the present embodiment. That is, the circumferential dimension R2 of the connection portion of the fixing portion 118 and the notch 116 of the first sleeve fixing member 113 may be greater than or equal to the width of the extension portion 122. As such, when the extension portion 122 is screwed into the fixing portion 118, the fixing portion 118 may be completely received into the extension portion 122.

It should be understood that, in some embodiments, the movable connection portion may be arranged in a substantially C-shaped structure, and the fixing portion 118 may be arranged in the substantially L-shaped structure.

In some embodiments, it may be possible to only arrange the fixing portion 118. At this point, the fixing portion 118 may be arranged in a substantially C-shaped structure as described in the previous embodiments, and its height H may be set to be slightly less than the thickness of the extension portion 122, thereby fixing the extension portion 122.

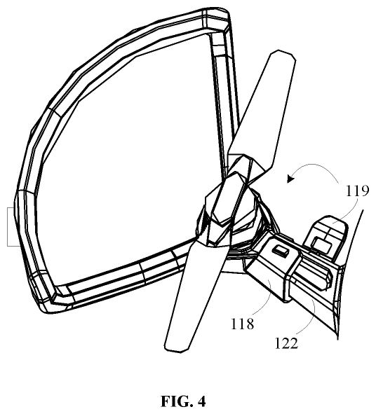

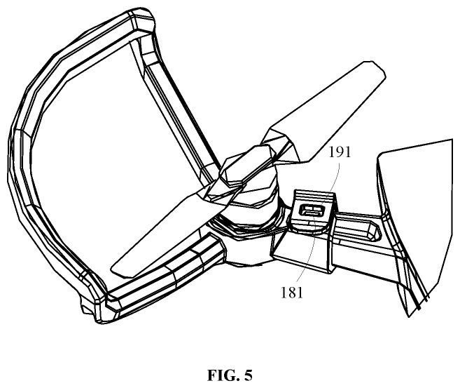

Referring to FIGS. 3-5, the assembly process of the blade guard may be as follow. First, the movable connecting portion 119 of the fixing assembly 112 may be rotated about a shaft connected to the fixing portion 118, such that the second sleeve fixing member 114 may be in an unfolded state. Subsequently, the first sleeve fixing member 113 may be fitted from below the support portion 121 of the arm 102 or below the motor 103 to ensure that the support portion 121 of the arm 102 or the motor 103 is sleeved in the cylindrical receiving cavity 115. Further, the cover 111 may be rotated along a direction shown in FIG. 3, such that the support portion 121 or the motor 103 may be completed enclosed by the cylindrical receiving cavity 115, and the extension portion 122 of the arm 102 may be screwed into the C-shaped structure of the fixing portion, as shown in FIG. 4. Furthermore, the movable connecting portion 119 may be rotated along a direction shown in FIG. 4, such the movable connecting portion 119 and the fixing portion 118 may formed a closed structure that is sleeved around the periphery of the extension portion 122. Lastly, the snapping part 181 disposed on the fixing portion 118 may be snapped into the slot 191 on the movable connecting portion 119 to lock the extension portion 122, as shown in FIG. 5.

It should be understood that when the blade guard 11 needs to be replaced, the blade guard 11 may be removed and replaced based on a reverse process of the assembly process described above, thereby realized the quick release function.

As described in the above embodiments, the notch 116 of the present disclosure may be used to allow the extension portion 122 to slide in from the notch 116 when the support portion 121 or the motor 103 is placed in the receiving cavity 115, and the extension portion 122 may be locked with the second sleeve fixing member 114 by rotation. As such, different shapes of extension portions may be used, for example, an extension portion having a relatively wider top portion and a relatively narrowed bottom portion may slide through the notch, and be rotated to the position of the second sleeve fixing member 114 for locking, thereby effectively ensuring the safety of the flight of the UAV 100.

The technical solutions of the present disclosure have been described by using the various embodiments mentioned above. However, the technical scope of the present disclosure is not limited to the above-described embodiments. It should be obvious to one skilled in the art that various modifications and improvements may be made to the embodiments. It should also obvious from the scope of claims of the present disclosure that the modified and improved embodiments are included in the technical scope of the present disclosure.

What is claimed is:

1. A blade guard for an unmanned aerial vehicle (UAV), the UAV comprising a body and a plurality of arms disposed on the UAV body, each arm including a support portion for supporting a motor and an extension portion for connecting the support portion and the UAV body, the blade guard comprising:
a cover; and
a fixing assembly, the fixing assembly includes a first sleeve fixing member and a second sleeve fixing member connected to the first sleeve fixing member;
wherein the first sleeve fixing member includes a receiving cavity and a notch connected to the receiving cavity, and when the support portion of the arm or the motor is received in the receiving cavity, the extension portion of the arm is rotatable along the notch to enable the extension portion of the arm to be received in the second sleeve fixing member, and the extension portion is then locked by the second sleeve fixing member.

2. The blade guard of claim 1, wherein the first sleeve fixing member is disposed between the cover and the second sleeve fixing member.

3. The blade guard of claim 2, wherein the notch opens along a circumferential direction of the first sleeve fixing member.

4. The blade guard of claim 2, wherein the receiving cavity is a cylindrical receiving cavity, and the support portion or the motor is inserted into the cylindrical receiving cavity along an axial direction of the cylindrical receiving cavity.

5. The blade guard of claim 2, wherein the second sleeve fixing member includes a fixing portion and a movable connecting portion, the fixing portion is fixedly connected to the first sleeve fixing member, and the movable connecting portion and the fixing portion form a closed structure that is sleeved around the extension portion.

6. The blade guard of claim 5, wherein one end of the movable connecting portion is pivotally connected to one end of the fixing portion, and the other end of the movable connecting portion is detachably connected with the other end of the fixing portion in a snap-fitting manner.

7. The blade guard of claim 5, wherein the fixing portion extends from the notch in a direction away from the cover.

8. The blade guard of claim 7, wherein a lower edge of the notch smoothly transitions into an inner surface of the fixing portion of the second sleeve fixing member.

9. The blade guard of claim 5, wherein the cover includes a cover body and two cover connecting portions, the two cover connecting portions extend outward from the fixing portion, an angle between the extending directions of the two cover connecting portions is less than 360°, and the two cover connecting portions away from the fixing portion are connected by the cover body.

10. An unmanned aerial vehicle (UAV) system, comprising:
a UAV including a UAV body and a plurality of arms disposed on the UAV body, each arm including a support portion for supporting a motor and an extension portion for connecting the support portion and the UAV body; and
a blade guard including a cover and a fixing assembly, the fixing assembly includes a first sleeve fixing member and a second sleeve fixing member connected to the first sleeve fixing member;
wherein the first sleeve fixing member includes a receiving cavity and a notch connected to the receiving cavity, and when the support portion of the arm or the motor is received in the receiving cavity, the extension portion of the arm is rotatable along the notch to enable the extension portion of the arm to be received in the second sleeve fixing member, and the extension portion is then locked by the second sleeve fixing member.
